(19) United States
(12) Patent Application Publication
(10) Pub. No.: US 2012/0226698 A1
(43) Pub. Date: Sep. 6, 2012

(54) FOOD OR DRINK PRODUCT SEARCHING AND MATCHING SYSTEM AND METHOD

(75) Inventors: OLIVIER SILVESTRE, Ramona, CA (US); Pierre Huguet, San Diego, CA (US)

(73) Assignee: VinoMatch, Inc.

(21) Appl. No.: 13/040,089

(22) Filed: Mar. 3, 2011

(51) Int. Cl. G06F 17/30

(52) U.S. Cl. 707/741; 707/758; 707/769; 707/736; 707/748; 707/E17.044; 707/E17.083; 707/E17.084

(57) ABSTRACT

A system and method for providing an information repository that optimizes profiles of sensory characteristics of food or drink products. The system receives user preferences or search criteria of similar sensory characteristics to match against food or drink products in a database with a very high degree of certainty or accuracy. The system and method also provide personalization to users, i.e. personal recommendations based on personal preferences, as well as product matching processes.

### BACKGROUND

This disclosure relates generally to a food or drink product searching and matching system, and more particularly to systems and techniques for generating a database of profiles of food or drink products and web-based applications for generating matches between user input data and the profiles.

Consumers of food and drink products, such as drink products like wine, have difficulty navigating store shelves, deciphering descriptive labels, or choosing a suitable food or drink product from a restaurant menu or wine list. The World Wide Web has made an enormous amount of information instantly available to Internet-capable devices, but such information has only served to further confuse and inundate consumers with useless data, particularly if they cannot adequately convey their personal tastes and preferences for particular foods or drinks. One major issue is that there is no Internet resource or database that can understand user tastes or preferences, and match those tastes and preferences with suitably-profiled food or drink objects in a database.

### SUMMARY

In general, this document discusses a system and method for providing an information repository that provides optimized quantitative profiles of sensory characteristics of food or drink products, and which can receive user preferences of similar sensory characteristics to match against food or drink products in a database with a very high degree of certainty or accuracy. The system and method also provide personalization to users, i.e. personal recommendations based on personal preferences, palate sensibility, and/or user knowledge or understanding levels of a food or drink product.

In one aspect, a system and method are implemented on a computing platform, and execute a process including receiving, from a client computer via a communications network, input data representing a plurality of sensory characteristics related to a food or drink product. The input data includes a quantitative value of each sensory characteristic from a scale of quantitative values. The process further includes accessing a database having food or drink product data for a plurality of food or drink products, the food or drink product data including a profile of sensory characteristics for each food or drink product of the plurality of food or drink products, and matching, based on the value for each sensory characteristic from the input data, the input data with the profile of sensory characteristics of one or more food or drink products of the food or drink product data in the database. The process further includes transmitting to the client computer information about the one or more food or drink products that most closely match the input data.

In another aspect, a computer-implemented method includes receiving, from a client computer via a communications network, sensory data input representing a plurality of discrete sensory characteristics related to a food or drink product. The method further includes determining a value for each sensory characteristic of the plurality of discrete sensory characteristics related to the food or drink product, the value being a quantitative representation of the respective sensory characteristic from a quantitative range defining the respective sensory characteristic. The method further includes accessing a database having food or drink product data for a plurality of food or drink products, the food or drink product data including a profile of sensory characteristics for each food or drink product of the plurality of food or drink products. The method further includes matching based on the value for each sensory characteristic, the sensory data with the profile of sensory characteristics of one or more food or drink products of the food or drink product data in the database.

In yet another aspect, a computer-implemented method for building a database of food and/or drink product data is presented. The method includes generating, using at least one data processor, a base profile of sensory characteristics of a food or drink product, the base profile being based at least partially on technical data received by the at least one data processor from technical data sources via a communications network. The method further includes generating an updated profile of the sensory characteristics of the food or drink product based on feedback data received by the at least one data processor, via the communications network and at least one client computer, from one or more users of the food or drink product.

Systems and methods consistent with the above approaches are described as well as articles that comprise a tangibly embodied machine-readable medium operable to cause one or more machines (e.g., computers, etc.) to result in operations described herein. Similarly, computer systems are also described that may include a processor and a memory coupled to the processor. The memory may include one or more programs that cause the processor to perform one or more of the operations described herein.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 is block diagram of a system for food or drink product searching and matching.

FIG. 2 is a functional block diagram of a food or drink product searching and matching application program.

FIG. 3 is a functional block diagram of a process for building a database and searching and matching food or drink products.

FIG. 4A illustrates an example of a user input window for receiving input data from a user.

FIG. 4B illustrates another user input window for receiving input data from a user.

FIGS. 5A and 5B illustrate various webpages for receiving user input for searching and matching food or drink products.

FIGS. 6A and 6B illustrate various webpages for displaying search results, product information, and purchase options, as well as product profile enhancement and optimization input windows.

FIG. 7 is a flowchart of a method for general food or drink product searching and matching.

FIG. 8 is a flowchart of a method for generating a catalog of food or wine products in a database.

FIG. 9 shows a feedback window of a graphical user interface.

FIG. 10 shows various input screens for receiving user feedback from a mobile device.

Like reference symbols in the various drawings indicate like elements.

### DETAILED DESCRIPTION

This document describes systems and methods for searching and matching food or drink products. In a preferred exemplary embodiment, a food or drink product is a wine product, such as a particular bottle, brand, or vintage of wine that can be represented by type (i.e. red, white, etc.), country, region, varietal or mix of varietals, year, and sensory characteristics such as color, aroma, taste, and any of a variety of flavors. As will be discussed further below, the present systems and methods are very suitable for a food or drink product like wine, since wine can be defined and profiled by a broad but standard range of discrete sensory characteristics, however the systems and methods described herein can be applied to any food product, such as meats, cheeses, fruits or vegetables, or any other drink product such as beer, spirits, juice or water.

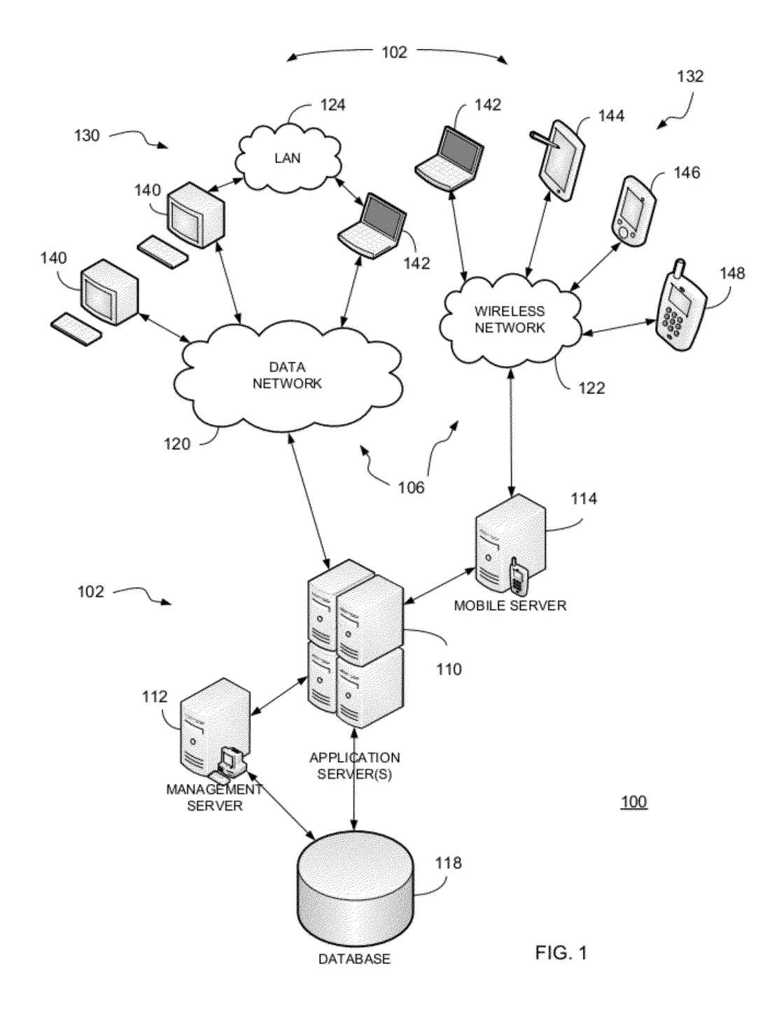

FIG. 1 is block diagram of a system 100 for food or drink product searching and matching. The system 100 generally includes a number of server computers 102 communicating with a number of client computers 104 via one or more communication networks 106. The server computers 102 execute and serve a web-based application that can also be executed and operated by each of the client computers 104, either in a client-based web browser application or in another locally-stored an executed client application. The infrastructure that provides the one or more communication networks 106 as well as the server computers 102 define also what is known as a “cloud” architecture for “cloud computing,” i.e. an architecture with which the client computers 104 can access and execute the computing services described herein.

The server computers 102 can include, without limitation, one or more application servers 110 for serving a food or drink product searching and matching application program to the client computers 104 via the communication networks 106. The server computers 102 can also include a management server 112 by which the food or drink product searching and matching application program is managed and administered. For instance, updates can be made to the food or drink product searching and matching application program by the management server 112. Also, customer data, advertisements, other content, and such can also be managed and controlled via the management server 112.

Advertising, coupons, promotions, etc., managed by the management server 112 can be based on search terms related to type and sensory characteristics of the food or drink product. For instance, based on what users search for, with input into any of the client computers 104, the server computers 102 can return advertisements for specific, sought-after food and/or drink products, close matches or pairings of other food and/or drink products, relevant merchants of food and/or drink products based on geo-location or accessibility, or other factors. Results that are generated for particular users from the management server 112 can be personalized, i.e. a particular user's profile, preferences and/or history can be used in generating a search result or match for food or drink products or related information. In one simplified example, based on tasting feedback and preference data from a particular user that indicate an affinity for sweeter wines, the server computers 102 can bias search results of sensory characteristics to sweeter wines as a match, as well as provide location data for a certain retail location that carries the sweeter wines. The server computers 102 may also link a promotion to one or more of the sweeter wines in the search result information.

The server computers 102 can further include a mobile server 114 for generating data for communication with one or more mobile devices via the communication networks 106. The mobile server 114 can communicate data of the food or drink product searching and matching application program with the application servers, but in accordance with a mobile application suitable for a mobile device.

The server computers 102 store, update and retrieve data from a database 118 that has food or drink product data for a large number of food or drink products. The food or drink product data includes a profile of sensory characteristics for each food or drink product. As will be described in further detail below, each profile starts as a base profile of initial settings for at least some of the sensory characteristics related to the relevant food or drink product. Each sensory characteristic is a qualitative representation of the food or drink, such as a taste, aroma and/or flavor, that can be defined and quantified along a quantitative scale or range. For example, the range can be a numerical range (i.e. from 1 to 10) or a qualitative-oriented quantitative scale (i.e. mild, medium, bold). Other scales or ranges can be used, but the base profile includes a particular base value for each scale or range, and therefore for each associated sensory characteristic that defines the food or drink product. Over time, the base profile of each food or drink product is adjusted and optimized with sensory data from user feedback entered into one or more of the client computers 104 and transmitted to the food or drink product searching and matching application program on the server computers 102, and eventually stored in the database 118.

The communication networks 106 can include one or more data networks 120 such as data networks that make up the Internet, for communicating with client computers 104, which includes network devices 130 or mobile devices 132. The data networks 120 can be any wired or wireless data network, such as fiber optic cable, coaxial cable, or other medium that operates according to a particular communication standard(s) and/or protocol(s). The communication networks 106 can also include one or more wireless networks 122 adapted specifically for communicating with mobile devices 132 according to one or more wireless standards and protocols, such as the Global System for Mobile Communications (GSM), Code Division Multiple Access (CDMA), Bluetooth, Radio Frequency Identification (RFID), or any other standards, protocols or variants thereof. The communication networks 106 can even include other networks such as a local area network (LAN) 124 for communications directly among the client computers 104. In one example, RFID or Near Field Communication (NFC) can be used for identifying a location of a particular product, or for wireless payment transactions for the product via a local application on a client computer 104, such as a smartphone. Wireless sensing and communication mechanisms, such as bar codes or scan codes, can be used to obtain profile information for a product via a mobile device used in proximity to the product, based on proximity data. The proximity data can also be used, alone or in conjunction with user profiles or preferences, to generate and “push” coupons or other promotions to the mobile device.

The network devices 130 can include desktop computers 140, laptop computers 142, tablet computers 144 or other network-capable devices such as switches, routers, terminals and interactive displays. The mobile devices 132 can include smart phones 146, mobile phones 148, or other mobile devices such as personal digital assistants, pagers, or even laptops 142 and tablet computers 144. Those having skill in the art will realize that there can be considerable overlap and mix among the client computers 130, and that such term shall not be limited by the specific exemplary implementation shown in FIG. 1.

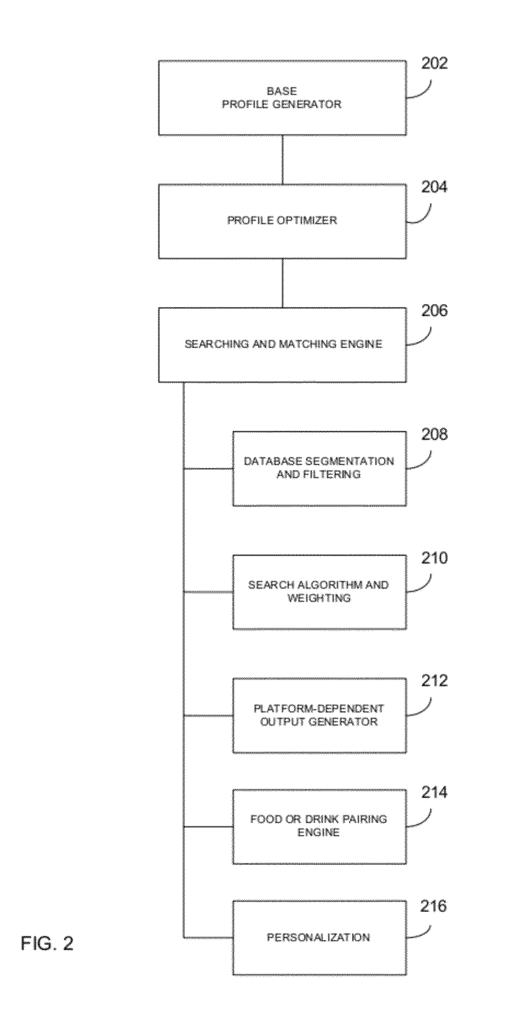

FIG. 2 is a functional block diagram of a food or drink product searching and matching system 200 in accordance with preferred exemplary implementations. The system 200 implements a food or drink product searching and matching algorithm, as preferably implemented by a food or drink product searching and matching application program. Food or drink searching and matching system 200 includes a base profile generator 202 that generates a base profile of values on a quantitative scale for each of a number of attributes of each food and/or drink that is part of the total number of foods and/or drinks stored in the database. The base profile generator 202 uses technical data, i.e. any attribute or description of the food or drink that impacts the taste of the food or drink, such as region of origin, basic description, year or vintage, manufacturing process information, or other information. Each base profile of quantitative values is stored in the database, and can be used as a look up table for a profile optimizer 204 or a searching and matching engine 206.

The profile optimizer 204 is a module of the food or drink product searching and matching application program that modifies, enhances, and updates selected base profiles using quantitative values of feedback or descriptions from producers of the food or drink, from experts and/or connoisseurs who have sampled and described the food or drink, and/or from other users who have sampled and described the food or drink, to generate an optimized profile. For example, the profile optimizer 204 can combine the weighted profiles or descriptions from two or more sources. Further, the profile optimizer 204 can augment a base profile with tasting information from users, connoisseurs, or experts, including a user who recently conducted a search for the food or drink product. The quantitative values can be weighted, and are used to adjust the quantitative values of each of the attributes that form the base profile of the food or drink.

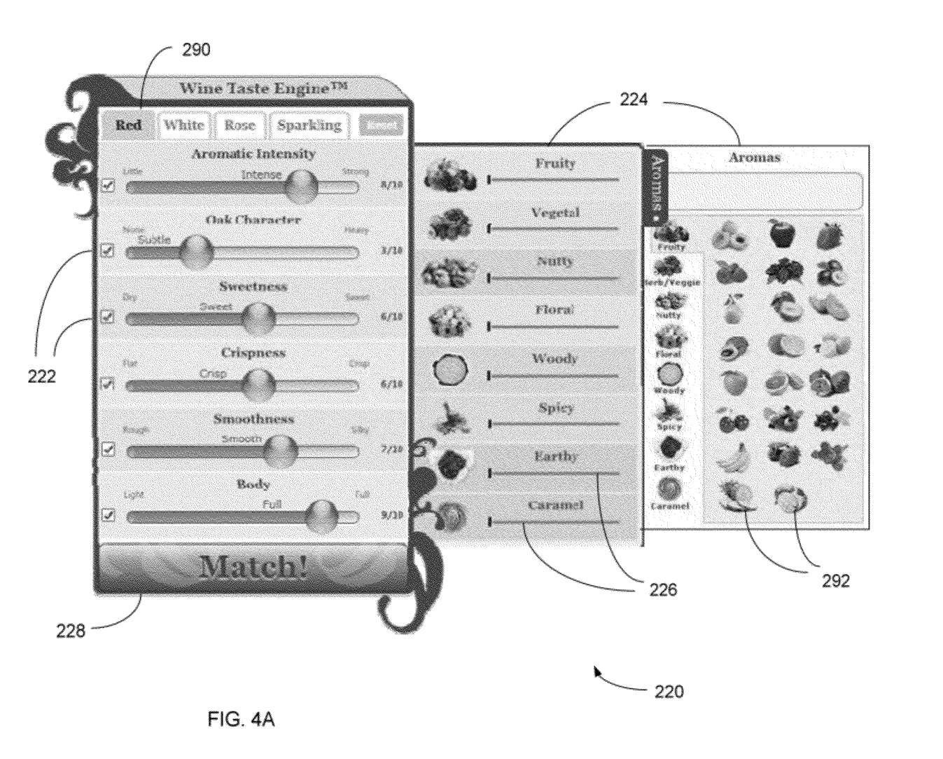

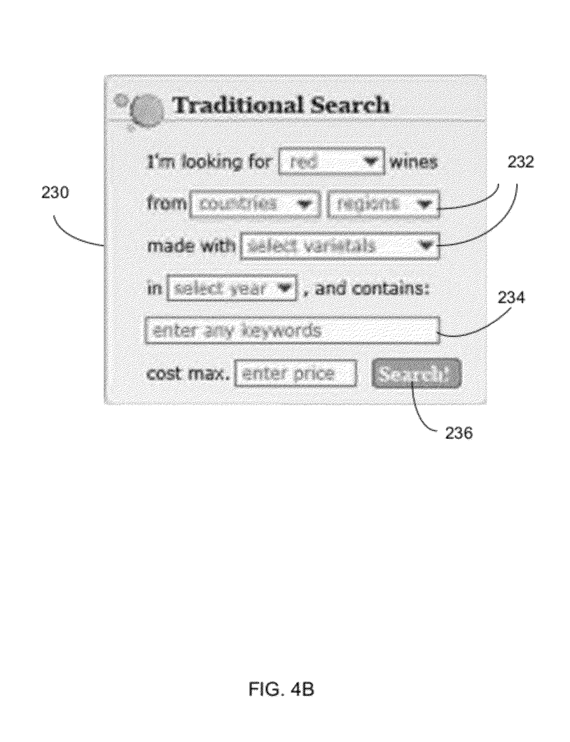

The searching and matching engine 206 receives input data from one or more of the client computers to access the database and match the input data with profiles stored in the database. As will be discussed below, the input data can include sensory data, i.e. preferences of sensory characteristics related to a food or drink product that is transformed into a quantitative value. Or, the input data can be a string of search terms such as food or drink type, geographical information of origin of the food or drink product, cost or price information, or any other key words or terms for searching the food or drink product. Preferred exemplary graphical user interfaces for receiving the input data are shown in FIGS. 4A and 4B and described further below.

The searching and matching engine 206 includes sub-modules and functions of database segmentation and filtering 208, which performs proprietary or known database segmentation and filtering based on the input data. The searching and matching engine 206 also includes a search algorithm and weighting module 210 that applies a weighting scheme to the input data for executing a search algorithm on the data in the database to obtain the best possible match or set of matches to the input data.

The searching and matching engine 206 also includes a platform-dependent output generator 212 that generates an output containing the results of the search engine, which are formatted specifically for a platform related to the type of client computer requesting the results. For instance, if the searching and matching engine 206 is communicating with a mobile device having a particular operating system platform, then the output generator 212 will generate a graphic-rich output that is formatted for that particular operation system platform for optimal usability.

A food or drink pairing engine 214 can generate suitable pairings with a particular set of food or drink product with other food or drink products, using relevant information from the database to make accurate and, in some instances, historically-validated recommendations. The food or drink pairing recommendations can be validated by user input in various ways: a “like or dislike” scheme, a “thumbs up/thumbs down” scheme, or by receiving and determining meaning behind user-supplied textual feedback. The searching and matching engine 206 also includes a personalization module 216, which can be integrated within any other module, can function as a standalone module, or be distributed among the entire searching and matching engine 206. The personalization module 216 can personalize search and match results based on demographic, psychographic, historical behavior, and even palate characteristics of any user.

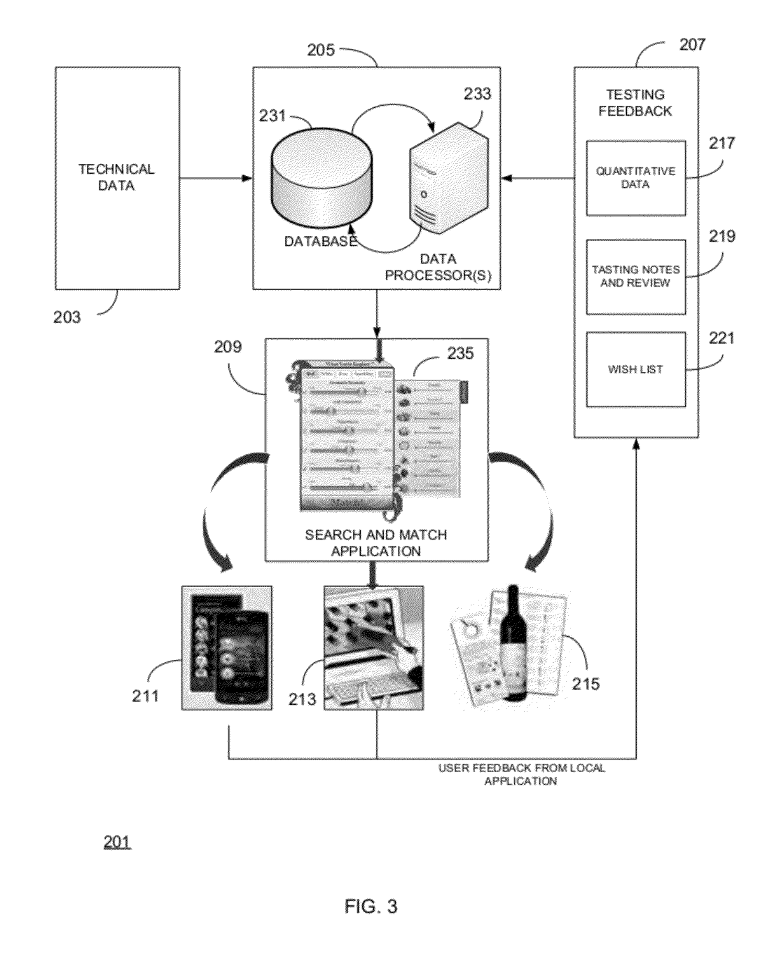

FIG. 3 is a functional block diagram of a platform 201 for executing a method for building a food or drink information repository 205 for searching and matching food or drink products. The repository includes a database 231 in which profiles and other information from one or more food or drink products is stored, as processed by one or more data processors 233. The database 231 can be one or more separate databases, i.e. many databases distributed over a number of computing environments for redundancy, security, performance, etc. The database 231 stores a base profile of quantitative values for a number of attributes or qualities for each food or drink product, based largely and initially on technical data 203 about each food or drink product. For example, for a wine product, the technical data 203 can include type of wine (red, white, rose, sparkling, etc.), grape type or blend, region in which the grapes were grown, region in which the wine product was made, year in which the wine product was made, and other technical data such as type of storage or container in which the wine product ferments (oak barrel, etc.). The technical data can further include data about weather or other environmental conditions at the time of any event in the life of the food or drink product. As stated above, technical data relates to any attribute or description of the food or drink that impacts the taste of the food or drink, such as region of origin, basic description, year or vintage, manufacturing process information, or other information.

The base profile is an estimated profile of each of a number of attributes or descriptions that define sensory characteristics of the food or drink, and can also be manually entered initially in the absence of some or all of the technical data. In some implementations, the attributes or descriptions are qualities that can be quantified. Each base profile is updated by combining the base profile quantitative values with quantitative values generated from testing feedback 207, which represents actual testing and user feedback of a food or drink product, as will be explained in further detail below. The profiles are continuously updated and refined to generate one or more optimized profiles for each food or drink product. For example, the system and method can generate an optimized profile for each of a segment of a demographic, i.e. based on age, gender, or the like.

A search and match application 209 receives user input, in the form of quantitative input data from one or more of various user input windows 235 displayed in a browser on a screen of a client computer, to execute a search of the optimized profiles and determine one or more food or drink product matches based on a closeness of the quantitative input data with quantitative values of the optimized profiles. Results of the search and match application 209 can be output to a mobile device 211, a personal computer 213, or as a hardcopy 215 in the form of a product tag or brochure. These outputs are illustrative only, and those of skill in the art will recognize that search results from the search and match application 209 can be output to a variety of devices or in a variety of formats.

For results that are output to a client computer such as a mobile device 211 or personal computer 213, the client computer can receive further user input in the form of tasting feedback 207 of the food or drink product. The tasting feedback 207 can be tasting feedback quantitative data 217, such as provided by a user input window similar to user input window 235, as will be explained further below. The tasting feedback 207 can also include tasting notes or a description of a review, each of which can be parsed for metadata and associated with the relevant food or drink product, or related food or drink products. For instance, a user may enter the text “this wine tastes great with lamb,” and therefore the keywords of at least “lamb” can be associated or tagged to the profile of the wine being tasted by the user, and which can be accessed and delivered for other users searching for a wine that complements lamb.

The tasting feedback can also include commercial-related information such as a wish list 221 by a consumer. The wish list can designate a matched food or drink product, as indicated in results delivered to a user, and which the user designates as desiring for future acquisition. For example, if a search is executed on wine products with particular sensory characteristics, and a set of wine products are provided as results of a matching, the user can designate certain resultant wine products as a “wish list.” The wish list can be stored in a database, for later search and access by the user or other parties, such as, for example, a merchant of the wine product in the wish list or wine products that resemble the wine products in the wish list. The wish list is also described in further detail below.

FIG. 4A illustrates one example of a graphical input window 220 for receiving user input data that is produces a set of quantitative values for a number of characteristics and attributes on which to search and match food or drink products. The graphical input window 220 shown in FIG. 3 exemplifies user input for a wine searching and matching application and system. The graphical input window 220 can be generated in a graphical user interface (GUI) and displayed in a graphical display such as a liquid crystal display (LCD), light emitting diode (LED) display, a cathode ray tube monitor, or any other computer screen or electronic device for the visual presentation of data such as text or graphics. The graphical input window 220 can be a portion of a larger window or display, a region within a broader GUI, or a standalone window generated by a local application, such as a browser application running on a client computer. The graphical input window 220 can be delivered to a web browser application as a standalone application or applet.

The graphical input window 220 includes a set of user-selectable tabs 221 that are selectable by a user using an input device such as a mouse, trackpad, touchpad or touch screen, for example, to select a type of food or drink to be searched. The graphical input window further includes a set of user-manipulable graphical controls 222 that are manipulable by a user using an input device as above, to indicate or represent a value on a quantitative range of one of a number of qualitative sensory characteristic. In implementations relating to wine products, for instance, the sensory characteristics can include, without limitation, aromatic intensity, oak character, sweetness, crispness, smoothness, body, or other sensory characteristics referred to in a wine context generally as “tasting notes.” Other attributes can include “finish,” “length,” or “weight” on a palette.

Each graphical control 222 represents a scale or range of a particular sensory characteristic, and enables a user to indicate a quantitative value for the sensory characteristic along the scale or range. The quantitative range or scale can be represented as a number, and/or described in text or graphics that can be mapped to a value or number. In some implementations, an application that generates the graphical input window 220 automatically and/or instantaneously determines, and even displays, the quantitative value for each of the sensory characteristics based on user manipulation of each of the graphical controls 222. In other implementations, the application sends the data representing the positioning of the graphical control 222 to a server computer or other computer, which then translates the data into the quantitative value.

In some implementations, the graphical control 222 is represented as a “slider” or button that is positionable on one of a large number of points along a linear or range scale. In other implementations, the graphical control 222 can be a tunable dial, a set of “up” and “down” controls to indicate relative positions on a range, or merely an input box such as for receiving a number between a stated range, or even one or more key words related to a particular sensory characteristic. Other variations or implementations are possible. As exemplified in FIG. 3, a slider button can be manipulated between a range of 0 to 10 for each sensory characteristic. For example, aromatic intensity can be represented as somewhere between “little” (i.e., 0) and “strong” (i.e., 10) along the scale. Other scales and ranges, whether numeric or alphanumeric, can also be used. Each of the graphical controls 222 can be selected or de-selected, as desired, using a selection button or other type of selection control.

The graphical input window 220 can further include one or more auxiliary windows 224, which can appear or disappear according to user input or selection. For example, as shown in FIG. 3, a first “aromas” auxiliary window 224 can be displayed to “slide out” to or “disappear” behind the main portion of the user input window having the graphical controls 222. Alternatively, the auxiliary windows 224 can be displayed immediately within or next to the graphical input window 220. Each auxiliary window 224 can include a number of additional graphical controls 226 that each can represent further sensory characteristics along a scale or range from which a quantitative value can be represented or determined. In some implementations, the additional graphical controls 226 provide further definition or granularity to the quantitative values represented by graphical controls 222, and can further enhance, for example, a base profile or updated profile of a food or drink product in the database. In the example shown, the “aromas” can comprise a range for “fruity,” “vegetal,” “nutty,” or the like, which further define or enhance the characterization of the primary sensory characteristics. In yet another example, another auxiliary window 224, also referring to “aromas” in the example of FIG. 4A, may display a number of graphical icons or pictures, or even a simple textual element, that represent discrete sensory characteristics or attributes. The icons or pictures can represent flavors of specific foods or spices, or any other definable characteristic of a food or drink product.

Once all of the input data from the graphical controls 222 and/or auxiliary controls 226 are received, a user can click on a “match” button 228, which when activated enables the local application to capture the position or quantitative value represented by the controls. The local application can further send the input data or the determined quantitative value information to a server through a communications network for executing a computer-implemented matching process.

FIG. 4B shows an alternative input window, a textual input window 230 for receiving textual input data from a user. The textual input window 230 is represented as a more traditional interface, with a number of drop-down menus 232 and/or text entry boxes 234. For example, in a wine searching and matching application, a first drop-down menu can display a number of selectable options for a general type of wine (red, white, rose, sparkling, etc.), other drop-down menus can display a number of selectable options for countries or regions of the wine, as well as various varietals or a particular year from a large number of vintage years. Exemplary data that can be received in the text entry boxes 234 includes price, year, type, varietal, or any of a number of keywords that relate to, or are descriptive of, a wine product. Those having skill in the art will recognize that the textual input window 230 can include any number or combination of drop-down menus or text entry boxes, or even other user input objects. The textual input window 230 can also be can be delivered to a web browser application as a standalone application or applet, on its own or as part of a larger graphical user interface, as can be seen in the following figures.

Variants of the user input windows 220 and 230 can also be provided or displayed within search results, such as a sponsored link region of a search engine web page, for example, or within an electronic commerce web page where a query term entered for a food or wine product would provoke serving and displaying of a user input window such as 220 or 230, along with results of results of the query.

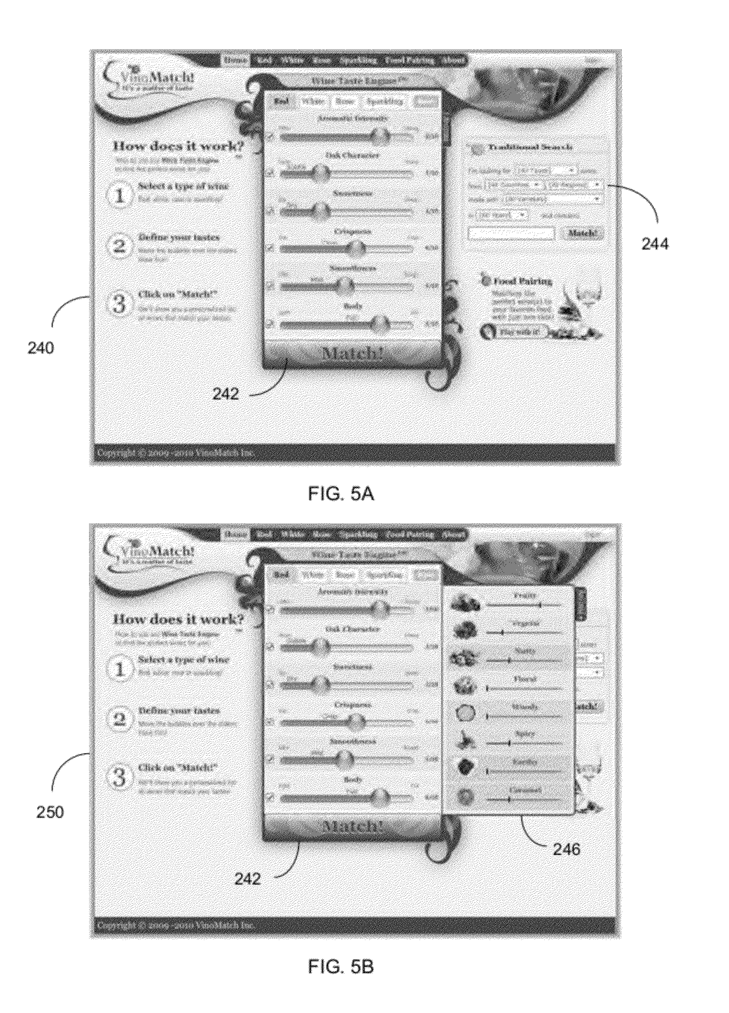

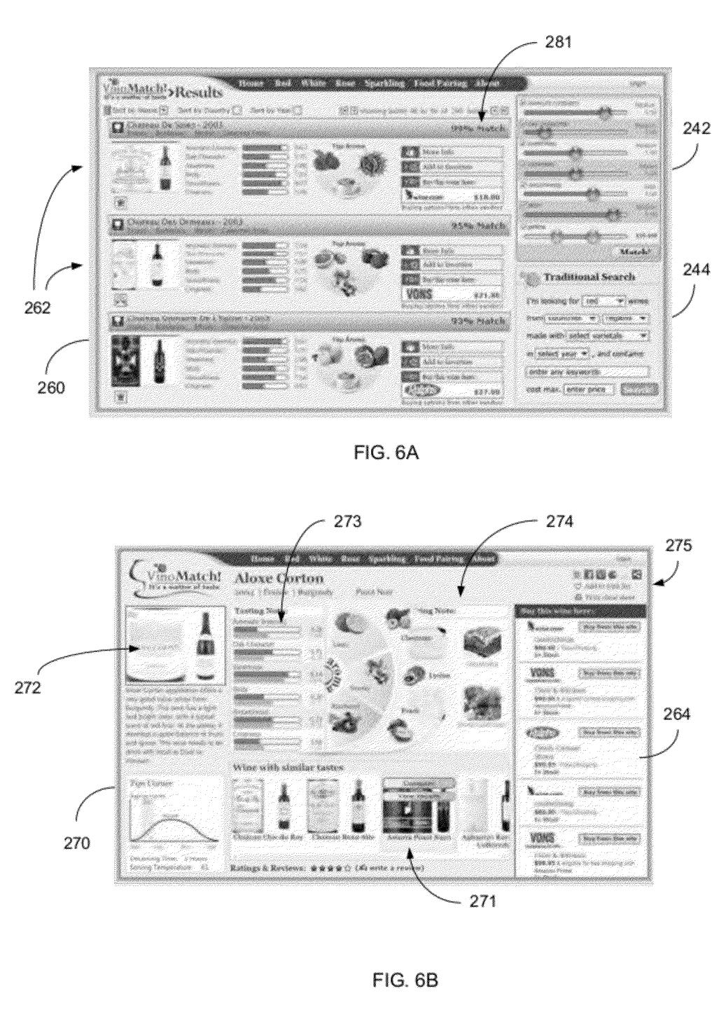

FIGS. 5A and 5B show several webpages, such as a homepage, of a food or drink product searching and matching system, and FIGS. 6A-6B show several search result pages with product descriptions, pairing results and purchasing options for one or more foods or drinks. Referring specifically to FIG. 5A, a webpage 240 includes at least one graphical input window 242 and/or textual input window 244, each of which receives user input data as described above with reference to FIGS. 3 and 4. As shown in FIG. 5B, a webpage 250 can include an auxiliary input window 246 in addition to a primary input window such as a graphical input window 242. In the example shown, the auxiliary input window 246 enables a user to provide further detail about the user's sensory preferences or feedback. Additionally, the webpage 250 can include other auxiliary input windows, such as the graphical icon or picture depiction of aromas shown in FIG. 4A.

FIG. 6A shows a results webpage 260 that includes results 262 of a search and match by the food or drink product searching and matching system. The webpage 260 can be a single page displayed in a browser application, or can have its numerous components distributed among a number of different interlinked pages. For instance, for smaller displays such as those found on mobile devices, the webpage 260 can be displayed in a number of navigable or scrollable pages.

The results 262 include one or more matched products, or products which most closely match inputted search data based on their product profiles, and which can be presented with a graphical representation of qualitative or quantitative ratings for one or more sensory characteristics, which may correspond with the input of the one or more sensory characteristics in the graphical input window 242, as described above with reference to FIG. 5A, which are transformed into quantitative values. The results can also include detailed descriptions of the matched products, either in text or graphic form, as well as one or more links to further information about each product. For instance, in the example shown for a wine matching application, a product description can include a narrative of tasting notes, with graphical depictions of top aromas for each wine. The description can also include an image of the label or bottle of the wine.

The results 262 may also include a control to enable a user to add a desired product to their personalized search history as a “favorite” for future access or search. Other information that can be provided for each result 262 includes a price or range of prices, buying options including links to merchants that carry the associated food or drink product, and other information.

The webpage 260 can include a graphical input window 242 and a textual input window 244, as described above. The input windows 242, 244 either allow further searching for more results 262, or allow feedback to be entered about any selected product from the results 262. The searching and matching application that generates the webpage 260 can also provide a ranking 281 or other indication of relevancy of each specific result. The ranking or relevancy of each result is computed based on user preferences and user inputs. An algorithm used to compute the relevancy can be personalized according to each specific user, or by any of a number of defined user groups. For example, individual users can indicate via the webpage 280 or other input window that specific sensory attributes have more importance (or, weight) than others, thus providing guidelines to provide even more relevance match on a per user basis.

FIG. 6B shows a match and compare webpage 270 that includes one or more selected products 272, which can be selected from a set of matched products as shown in results 262 of FIG. 6A, (i.e. from a “more input” tab) or which are returned based on a user search for the one or more selected products. Data describing the one or more selected products 272 is stored in the database and associated with a profile of the product(s). Using a single selected product as an example, the webpage 270 can display a graphical or textual input window, such as is described above, that presents a graphical or textual quantitative and/or qualitative description of one or more sensory characteristics of the product. The input window can be further manipulated by a user to gather user feedback about any of the sensory characteristics. For example, a user can move one of the six “slider” controls to better characterize their own tastes of the product based on the returned description.

The webpage 270 can also include a pairing window 274 having pairing notes and descriptions of other foods or drinks that can be paired with the one or more selected products 272. Each of the pairings can be either graphically or textually represented in the pairing window. The webpage 270 can also include purchase options 264 as banner ads or links to one or more e-commerce websites or “brick-and-mortar” stores that carry at least one of the matched products, or other products closely resembling the matched products. The purchase options 264 can include a control or button that immediately links to another website from which the user can purchase a particular desired product.

A match and compare webpage such as webpage 270 can further include a recommendation area 271 within the graphical user interface that provides recommendations of other food or drink products, such as other food or drink products with similar tastes or other characteristics as a selected food or drink product 272 from a results webpage, as defined by their profiles, or which are complementary to the selected food or drink product 272 in other ways.

In some exemplary implementations, a restaurant can provide information describing meals or dishes they offer, using the slider interface to describe the primary taste and aroma of each of their dishes, for example. While food attributes will be different than attributes for a drink such as wine (i.e.: salt, fat, oily, etc.) the same concepts apply. Once the food characteristics are received by the system, including taste and aroma attributes whether quantified or qualified, a food-drink pairing module will execute a pairing algorithm to provide a user or the restaurant with an accurate food-wine pairing ranking or table about which drink product best complements their food products. The food information can also be used to provide more general pairing for all users and even create a entire section dedicated to food where users can search for specific food tastes and aromas, and the system can provide the food information or third party recipes for a specific food dish matching their search criteria. In still yet other implementations, the system can provide, via the webpage 270, information as to which restaurant of a number of restaurants represented in the database offer the food dish that matches a user's preferences or search criteria. Accordingly, restaurants or other purveyors of food or drink products are incentivized to provide information to the system, including promotional information.

For similar food or drink products, i.e. a different but similar bottle of wine in a wine searching and matching application, the recommendation area 271 can provide control or selection buttons to enable a user to select one of the recommended other similar food or drink products for comparison to the selected food or drink product 272, which comparison can be displayed in a comparison window 273. As shown, the comparison underlays the quantitative values of the number of sensory characteristics of the other food or drink product to the same number of sensory characteristics of the selected food or drink product 272. Other comparisons, such as overlays, side-by-side representations, and other graphical depictions of comparisons can be employed.

Information from any of the webpages or screens depicted herein can be shared via any of a number of email applications or social networking applications, such as Facebook®, Twitter®, etc. by a user selecting a sharing icon from a sharing region 275 in FIG. 6B. The sharing region 275 can initiate any third party sharing application, or can execute a proprietary sharing function. The sharing region 275 can also include a function to add any information, such as a selected product 272 or any recommended product from recommendation area 271, to a “wish list” or “shopping cart,” which saves the information in the database along with identifying information of the user. Accordingly, the user can revisit their wish list for further analysis or to find out where to purchase the items in the wish list. Alternatively, merchants or other providers of food or drink products can market goods and services to particular demographics based on analytics performed on sole or aggregated wish lists. As an example, a wine seller that is in near proximity to a location of a user can use the user's wish list to determine whether or not the wine seller has wish list products in stock. If not, the wine seller can generate a promotion of other goods or services that might interest the user, which can be based on the wish list as well as other information in the database, including user historical behavior, psychographics, or other data.

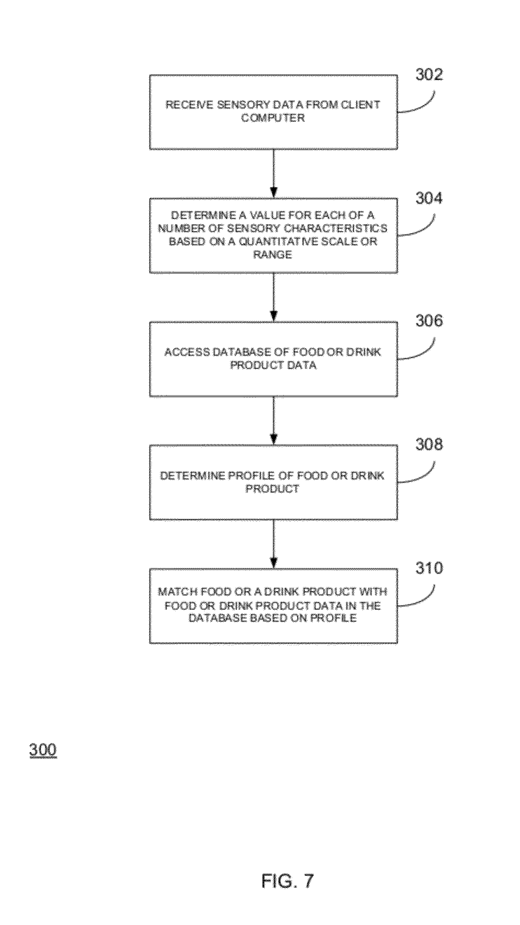

FIG. 7 is a flowchart of a method 300 for food or drink product searching and matching. At 302 sensory data representing a number of discrete sensory characteristics related to a food or drink product is received from a client computer. At 304, a value for each sensory characteristic of the number of discrete sensory characteristics related to the food or drink product is determined. The value is a quantitative representation of the respective sensory characteristic from a quantitative scale or range defining the respective sensory characteristic. The value can be determined locally and/or instantaneously based on user input, i.e. by the user operating a graphical “slider” or other graphical input object, as described above. The value can also be determined from the sensory data by a local application program running on the client computer, or the sensory data can be transmitted to a server computer via a communications network where it can be determined by a server-based food or drink product searching and matching program.

At 306, a database having food or drink product data for a number of food or drink products is accessed. The food or drink product data includes a profile of base and/or adjusted sensory characteristics for each food or drink product of the number of food or drink products in the database, and at 308 a profile of one or more of the number of food or drink products is determined from the food or drink product data. At 310, the sensory data from the client computer is ultimately matched with the profile of sensory characteristics of one or more food or drink products of the food or drink product data in the database, based on the value for each sensory characteristic.

In yet another implementation, a user can control a client computer to perform searching and matching in an off-line environment on a locally-stored database, such as, for example, on a database representing the user's personal wine cellar or a set of preferred wines via a mobile device. For example, if a user's client computer is a mobile device, a store or merchant, or restaurant or other shop can automatically, or by user selection, determine a location of the user's mobile device, and automatically define a subset of the database, from which to search and match food or wine products. Additionally, the same function can be executed against any discrete and geographically-specific collection of food or wine product, such as a personal wine collection or small cellar in a building.

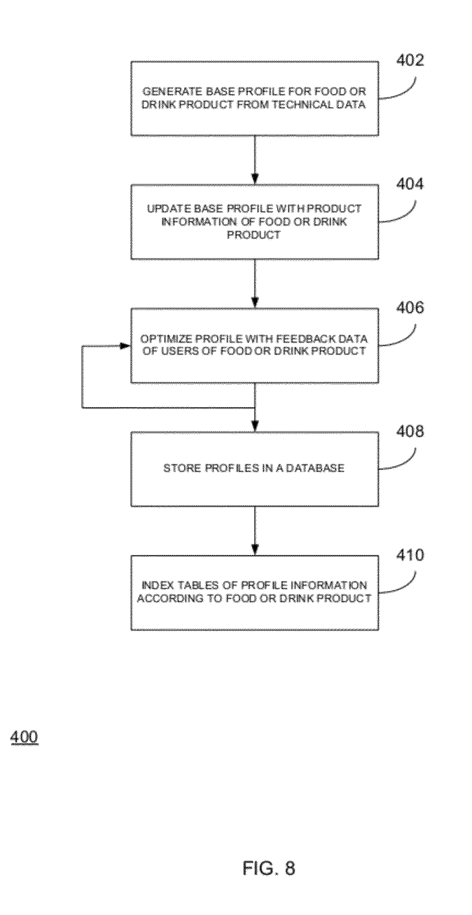

FIG. 8 is a flowchart of a method 400 for generating a database or electronic catalog of profiles for a set of food or drink products in accordance with implementations described herein. At 402 a base profile for a food or drink product is generated as much as possible from technical data available online or offline of the communications network. The technical data can be provided by product information, such as label or packaging data, marketing information, information from published reviews or evaluations, or technical data from an evaluation laboratory. For a wine product, as an example, technical data can include varietal type or percentage blend of varietals, a region in which the grapes were grown or harvested, a winemaking process, vintage, and any relevant technical data that can help estimate the base profile and quantify each sensory characteristic of the wine such as its color/aroma/taste/flavor profile.

At 404, the base profile is updated with additional product information related to the food or drink product. The base or an enhanced profile represents a number of sensory characteristics that can be experienced by a consumer of the food or drink, such as sight, taste, smell, color, aroma, flavors, etc., and which can be received from one or more data sources such as the product's manufacturer or producer (i.e., a winemaker who has evaluated and characterized the sensory characteristics of a wine product. The updated profile can be stored in the database as a reliable and indexed source of information for the food or drink product.

At 406, the profile of the food or drink product is optimized with feedback from specific users of the food or drink product. For instance, to personalize a searching and matching experience, the database can include a table of optimized profiles associated with the user's of the associated food or drink, i.e., experts or connoisseurs in a field related to a particular food or drink product, and other users (amateurs, beginner tasters, etc.) of the food or drink product so as to relate a particular user's experience with the food or drink product. Accordingly, future searches by that particular user can take into account a history of that user's experience to optimize the profiling and matching of food or drink products that correspond with the particular user's preferences or historical patterns.

At 408 all of the profiles and associated information are stored in the database. The profiles and associated information can include links to other data sources, which can be formatted and served to a user of the system as a hyperlink or as an information source about the food or drink product. At 410, the profile information, as well as other information about the food or drink product, are indexed for future searching and matching by a searching and matching system as described above. It should be readily apparent that steps of method 400 can be accomplished in any order, or in no particular order, to achieve desired results.

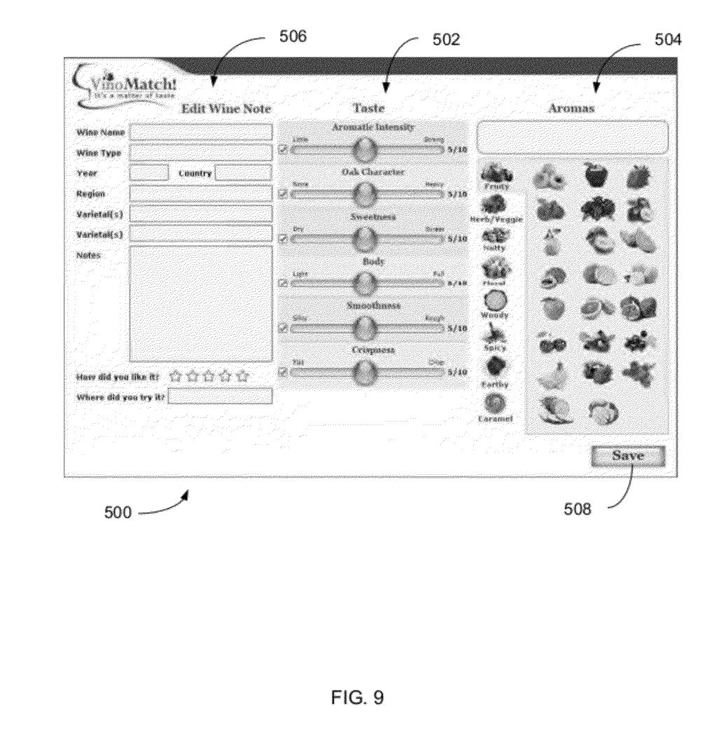

To optimize the profile of a product as above, the system and method described herein can provide a feedback window 500 that can be displayed on any client computer to solicit and receive user input and feedback based on any sensory experiences of the user about the product, as shown in FIG. 9. The feedback window 500 can include a set of graphical controls 502 that enable a user to manipulate a graphical by an input device so as to represent a sensory characteristic or attribute as a quantitative value. In preferred exemplary implementations, the graphical controls 502 are similar, if not identical, to the graphical controls 222 provided to a user to search for and match food or drink products. For instance, the feedback window 500 can further include one or more auxiliary windows 504 to represent and receive further detail about the user's sensory experiences, such as a graphical depiction of a number of possible selectable aromas that might accompany a wine product.

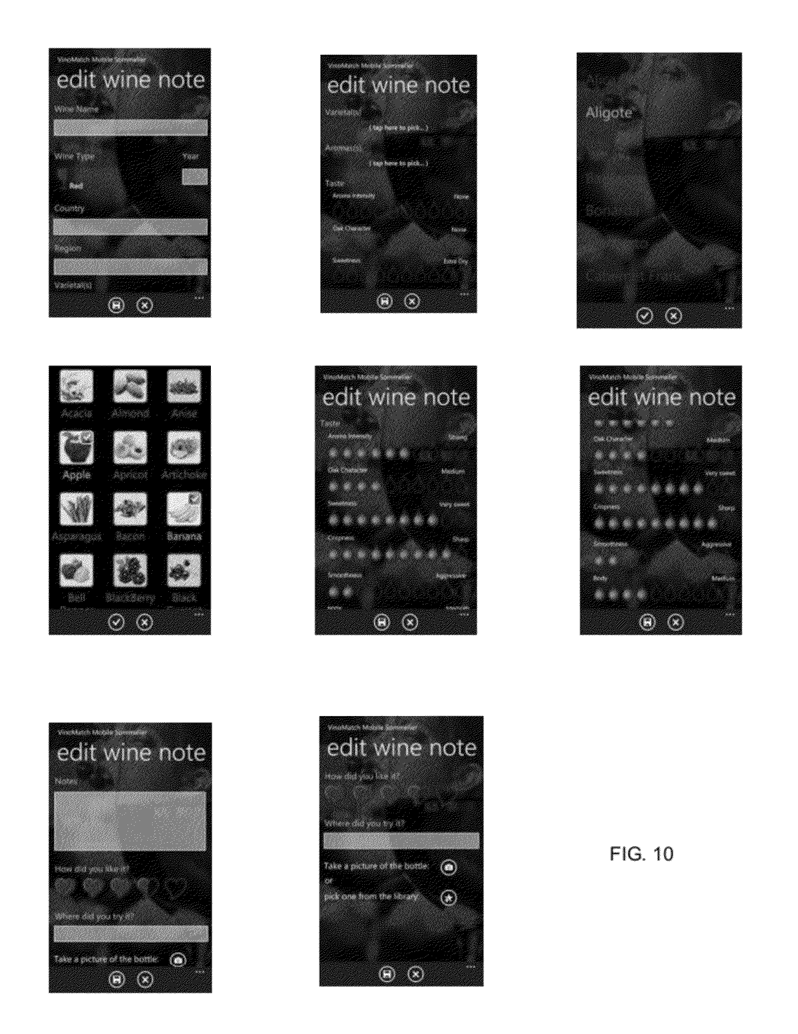

The feedback window 500 can also include an edit box with one or more text entry blocks for receiving text in answer to specific questions or general solicited input. Each of the windows or controls of the feedback window can be provided within another window of a display screen or graphical user interface, such as a browser application. Further, each window or control can be tailored for a specific type or size of display. For example, the feedback window can be formatted specifically for a smart phone client computer, and distributed among a number of different displays, as shown in FIG. 10. Alternatively, the feedback window 500 can aggregate all of the controls, auxiliary windows, and/or text boxes or regions within a single GUI. The feedback window can also include a “save” button to execute a function to store all data to a memory or the database once data has been entered by the user.

Some or all of the functional operations described in this specification can be implemented in digital electronic circuitry, or in computer software, firmware, or hardware, including the structures disclosed in this specification and their structural equivalents, or in combinations of them. Embodiments of the invention can be implemented as one or more computer program products, i.e., one or more modules of computer program instructions encoded on a computer readable medium, e.g., a machine readable storage device, a machine readable storage medium, a memory device, or a machine-readable propagated signal, for execution by, or to control the operation of, data processing apparatus.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of them. A propagated signal is an artificially generated signal, e.g., a machine-generated electrical, optical, or electromagnetic signal, that is generated to encode information for transmission to suitable receiver apparatus.

A computer program (also referred to as a program, software, an application, a software application, a script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to, a communication interface to receive data from or transfer data to, or both, one or more mass storage devices for storing data, e.g., magnetic, magneto optical disks, or optical disks.

Moreover, a computer can be embedded in another device, e.g., a mobile telephone, a personal digital assistant (PDA), a mobile audio player, a Global Positioning System (GPS) receiver, to name just a few. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Certain features which, for clarity, are described in this specification in the context of separate embodiments, may also be provided in combination in a single embodiment. Conversely, various features which, for brevity, are described in the context of a single embodiment, may also be provided in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Particular embodiments of the invention have been described. Other embodiments are within the scope of the following claims. For example, the steps recited in the claims can be performed in a different order and still achieve desirable results. In addition, embodiments of the invention are not limited to database architectures that are relational; for example, the invention can be implemented to provide indexing and archiving methods and systems for databases built on Models other than the relational model, e.g., navigational databases or object oriented databases, and for databases having records with complex attribute structures, e.g., object oriented programming objects or markup language documents. The processes described may be implemented by applications specifically performing archiving and retrieval functions or embedded within other applications.

1. A computer-implemented method comprising:
receiving, from a client computer via a communications network, sensory data input representing a plurality of discrete sensory characteristics related to a food or drink product;
determining a value for each sensory characteristic of the plurality of discrete sensory characteristics related to the food or drink product, the value being a quantitative representation of the respective sensory characteristic from a quantitative range defining the respective sensory characteristic;
accessing a database having food or drink product data for a plurality of food or drink products, the food or drink product data including a profile of sensory characteristics for each food or drink product of the plurality of food or drink products; and
matching based on the value for each sensory characteristic, the sensory data with the profile of sensory characteristics of one or more food or drink products of the food or drink product data in the database.

2. The computer-implemented method in accordance with claim 1, wherein the food or drink product is a wine product.

3. The computer-implemented method in accordance with claim 1, wherein the food or drink product is a spirit.

4. The computer-implemented method in accordance with claim 2, wherein the plurality of discrete sensory characteristics includes a color, flavor, aroma and taste of wine related to the wine product.

5. The computer-implemented method in accordance with claim 1, wherein the sensory data is received in a query executed on the client computer, the query being associated with a search of the one or more food or drink products that are to be matched with the sensory data.

6. The computer-implemented method in accordance with claim 1, further comprising updating, by at least one data processor, the profile of sensory characteristics of at least one food product of the one or more food or drink products that are matched with the sensory data.

7. The computer-implemented method in accordance with claim 6, further comprising storing, by the one or more processors, an updated profile of the at least one food or drink product based on the sensory data.

8. The computer-implemented method in accordance with claim 1, wherein at least one of the receiving, the determining, the accessing, and the matching are performed by at least one data processor.

9. A computer-implemented method for building a database of food and/or drink product data, the method comprising:
generating, using at least one data processor, a base profile of sensory characteristics of a food or drink product, the base profile being based at least partially on technical data received by the at least one data processor from technical data sources via a communications network; and
generating an updated profile of the sensory characteristics of the food or drink product based on feedback data received by the at least one data processor, via the communications network and at least one client computer, from one or more users of the food or drink product.

10. The method in accordance with claim 8, further comprising storing the base profile and the updated profile in the database.

11. The method in accordance with claim 10, wherein the base profile and the updated profile are stored in a table indexed by the associated food or drink product.

12. The method in accordance with claim 9, wherein the technical data sources include a producer or regional source of the food or drink product.

13. The method in accordance with claim 9, wherein the technical data includes product information associated with the food or drink product.

14. The method in accordance with claim 9, wherein the feedback data is received via a graphical input window displayed on the at least one client computer.

15. The method in accordance with claim 9, wherein the sensory characteristics are each weighted according to a weighting scheme to generate the base profile.

16. A computer-implemented method comprising:
receiving, from a client computer via a communications network, input data representing a plurality of sensory characteristics related to a food or drink product, the input data providing a quantitative value of each sensory characteristic from a scale of quantitative values;
accessing a database having food or drink product data for a plurality of food or drink products, the food or drink product data including a profile of sensory characteristics for each food or drink product of the plurality of food or drink products;
matching, based on the value for each sensory characteristic from the input data, the input data with the profile of sensory characteristics of one or more food or drink products of the food or drink product data in the database; and
providing to the client computer information about the one or more food or drink products that most closely match the input data.

17. The computer-implemented method in accordance with claim 1, wherein the food or drink product is a wine product.

18. The computer-implemented method in accordance with claim 16, further comprising generating a graphical input window of graphical controls for receiving the input data.

19. The computer-implemented method in accordance with claim 18, wherein each graphical control includes a slider having a button that can be positioned along a range that corresponds to the scale of quantitative values for the associated sensory characteristic.

20. The computer-implemented method in accordance 19, wherein transmitting information about the one or more food or drink products includes generating a graphical display representing the profile of the one or more food or drink products that most closely match the input data.
